(19) United States
(12) Patent Application Publication
(10) Pub. No.: US 2025/0165758 A1
(43) Pub. Date: May 22, 2025

(54) INFORMATION PROCESSING APPARATUS AND INFORMATION PROCESSING METHOD

(71) Applicant: Sony Group Corporation, Tokyo (JP)

(72) Inventor: Hiroyuki Katchi, Tokyo (JP)

(21) Appl. No.: 18/730,419

(22) PCT Filed: Feb. 27, 2023
(86) PCT No.: PCT/JP2023/007153

§ 371 Date: Jul. 19, 2024

(30) Foreign Application Priority Data
Mar. 3, 2022 (JP) 2022-032498

(51) Int. Cl. G06N 3/0495; G06N 3/0464

(52) U.S. Cl. CPC G06N 3/0495; G06N 3/0464

(57) ABSTRACT

An information processing apparatus (1) includes a processing unit (11) that generates divided compressed data (dc) by dividing and compressing a coefficient matrix (km) of a neural network, which has dimensions in a filter direction and in other directions and is adjusted to include many zero coefficients, in a divided range designed to be unable to be set freely in the filter direction but to be able to be set freely in the other directions.

### FIELD

The present disclosure relates to an information processing apparatus and an information processing method.

### BACKGROUND

Various technologies related to compression of a coefficient matrix of a neural network have been proposed (see, for example, Patent Literature 1).

### CITATION LIST

### Patent Literature

Patent Literature 1: JP 2021-82289 A

### SUMMARY

### Technical Problem

For example, in a device or the like having a small buffer size, division of processing using a neural network is conceivable. There is room for studying a technology suitable for division of processing.

One aspect of the present disclosure provides a technology suitable for division of processing using a neural network.

### Solution to Problem

An information processing apparatus according to one aspect of the present disclosure includes a processing unit that generates divided compressed data by dividing and compressing a coefficient matrix of a neural network, which has dimensions in a filter direction and in other directions and is adjusted to include many zero coefficients, in a divided range designed to be unable to be set freely in the filter direction but to be able to be set freely in the other directions.

An information processing apparatus according to one aspect of the present disclosure includes a processing unit that restores divided compressed data generated by dividing and compressing a coefficient matrix of a neural network, which has dimensions in a filter direction and in other directions and is adjusted to include many zero coefficients, in a divided range designed to be unable to be set freely in the filter direction but to be able to be set freely in the other directions.

An information processing method according to one aspect of the present disclosure includes generating divided compressed data by dividing and compressing a coefficient matrix of a neural network, which has dimensions in a filter direction and in other directions and is adjusted to include many zero coefficients, in a divided range designed to be unable to be set freely in the filter direction but to be able to be set freely in the other directions.

### BRIEF DESCRIPTION OF DRAWINGS

FIG. 1 is a diagram illustrating a schematic configuration example of an information processing apparatus 1 and an information processing apparatus 2 according to an embodiment.

FIG. 2 is a diagram illustrating an example of a coefficient matrix km.

FIG. 3 is a diagram illustrating an example of compression.

FIG. 4 is a diagram illustrating an example of division compression.

FIG. 5 is a diagram illustrating an example of a shape of a divided range.

FIG. 6 is a diagram illustrating an example of a shape of a divided range.

FIG. 7 is a diagram illustrating an example of divided compressed data dc.

FIG. 8 is a diagram illustrating an example of a sparse matrix.

FIG. 9 is a diagram illustrating a specific example of the coefficient matrix km and the divided compressed data dc.

FIG. 10 is a diagram illustrating a specific example of the divided range.

FIG. 11 is a diagram illustrating a portion corresponding to a divided range Δ1 in the divided compressed data dc.

FIG. 12 is a diagram illustrating a portion corresponding to a divided range Δ2 in the divided compressed data dc.

FIG. 13 is a diagram illustrating a portion corresponding to a divided range Δ3 in the divided compressed data dc.

FIG. 14 is a diagram illustrating another specific example of the divided range.

FIG. 15 is a diagram illustrating portions corresponding to a divided range Δ11 to a divided range Δ14 in the divided compressed data dc.

FIG. 16 is a diagram illustrating portions corresponding to the divided range Δ11 to the divided range 414 in the divided compressed data dc.

FIG. 17 is a diagram illustrating portions corresponding to the divided range Δ11 to the divided range Δ14 in the divided compressed data dc.

FIG. 18 is a diagram illustrating portions corresponding to the divided range Δ11 to the divided range Δ14 in the divided compressed data dc.

FIG. 19 is a diagram illustrating another specific example of the divided range.

FIG. 20 is a diagram illustrating a portion corresponding to a divided range Δ21 in the divided compressed data dc.

FIG. 21 is a diagram schematically illustrating processing by a processing unit 21.

FIG. 22 is a diagram schematically illustrating processing by the processing unit 21.

FIG. 23 is a flowchart illustrating an example of processing (information processing method) executed by the information processing apparatus 1 and the information processing apparatus 2.

FIG. 24 is a block diagram illustrating a hardware configuration example of the apparatus.

### DESCRIPTION OF EMBODIMENTS

Hereinafter, an embodiment of the present disclosure will be described in detail with reference to the drawings. Note that, in the following embodiments, the same components are denoted by the same reference signs to omit redundant description.

The present disclosure will be described according to the following order of items.
0. Introduction
1. Embodiment
2. Modified Example
3. Hardware Configuration
4. Example of Effect

### 0. Introduction

A neural network such as a deep neural network (DNN) has become a technology leading development of AI technology in recent years. The neural network is advantageous mainly in terms of a wide application range, high performance, and ability to cover data and learning in an end-to-end manner. On the other hand, it has a problem that the amount of calculation and the amount of memory required are large. Many studies have been made to reduce the amount of calculation and the amount of memory of the neural network. For example, a technology called Pruning for removing redundancy of the neural network is known.

Pruning is a method for removing a redundant connection relationship in (a model of) a neural network, and is realized by turning many coefficients to 0. Many layers constituting the neural network, for example, a convolutional layer, a fully connected layer, and the like are processed by product-sum operation. In the product-sum operation, the result of the product-sum with 0 is the same as that obtained when the operation is skipped. In a model in which many zeros are included in a weight due to Pruning, the amount of operation can be reduced by skipping the operation. By utilizing the fact that there are many zeros, it is possible to compress the weight with a combination of a non-zero coefficient and an expression indicating the position of the non-zero coefficient, and reduce the memory usage.

Since a neural network easily accelerates processing by utilizing data reusability and extracting the degree of parallelism of instructions, the neural network is sometimes processed by dedicated hardware such as a graphics processing unit (GPU) or an accelerator instead of a central processing unit (CPU). Usually, the accelerator or the like has an internal buffer (buffer memory), and executes processing using the neural network on data read into the internal buffer. Division of processing may be needed in consideration of the balance between the internal buffer and the weight of a model or an input/output size. For example, in an environment in which resources are limited to a microcomputer level as in the case of Internet of Things (IoT), the size of the internal buffer is considerably reduced, and thus the division of processing highly probably occurs. Regarding the division processing, for example, there are problems as described below.

A first problem is that coefficients of a neural network subjected to Pruning need to be compressed so that they can be subjected to division processing. This is because the density of the coefficients before compression (the ratio of non-zero coefficients to all the coefficients) varies depending on the position of the weight to be processed, and thus, when the previously used coefficients are to be read again, unless the number of the non-zero coefficients is counted before they are read again, where the non-zero coefficients are arranged on the internal buffer is lost.

A second problem is that it is necessary to efficiently express various variations of shapes of components and coefficients of a neural network. The components of the neural network are diverse, and various data paths for a convolution layer are conceivable, such as a one-dimensional (1D) convolution layer, a two-dimensional (2D) convolution layer, a depthwise convolution layer, and a pointwise convolution layer. Even for the same type of convolution layer, the shape of the coefficients may vary from layer to layer.

A third problem is to restore compressed data itself. It is desirable to efficiently distinguish between a non-zero coefficient and a zero coefficient to restore the non-zero coefficient and send the same to an operation unit.

At least some of the above-described problems can be addressed by the disclosed technology. For example, regarding the first problem, data is divided and compressed in a divided range set according to the size of the internal buffer. Regarding the second problem, the divided range is designed to be able to be set freely to some extent. Regarding the third problem, one or more non-zero coefficients are found and processed in one cycle in a decoder used for combining.

### 1. Embodiment

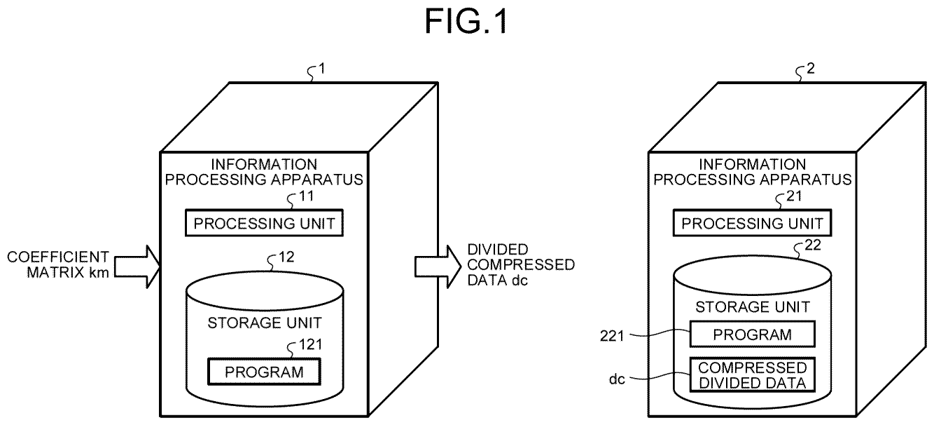

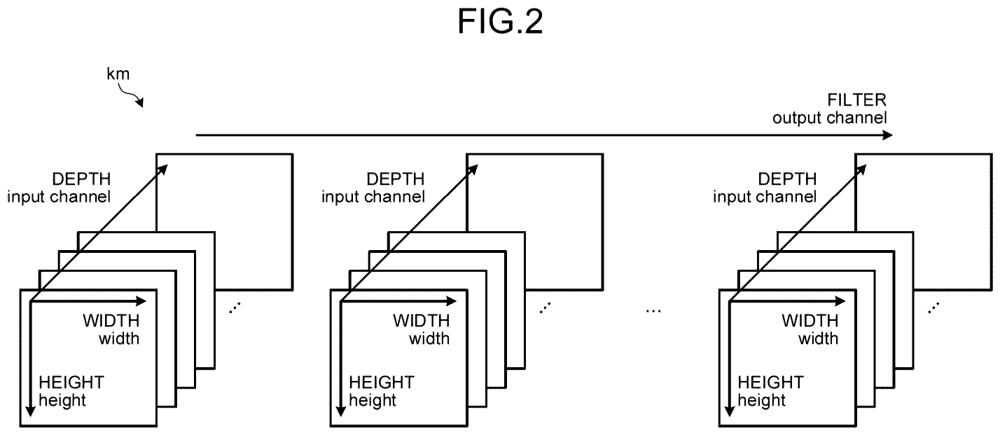

FIG. 1 is a diagram illustrating a schematic configuration example of an information processing apparatus 1 and an information processing apparatus 2 according to an embodiment. The information processing apparatus 1 compresses a coefficient matrix km and generates divided compressed data dc. The information processing apparatus 2 restores and uses the divided compressed data dc. Examples of the compression include encoding. Examples of the restoration include decoding. As long as there is no contradiction, the compression may be read as the restoration as appropriate and vice versa, and the encoding may be read as the decoding as appropriate and vice versa. The coefficient matrix km will be described with reference to FIG. 2.

FIG. 2 is a diagram illustrating an example of the coefficient matrix km. The coefficient matrix km is a multi-dimensional matrix in which coefficients of a neural network are described. Examples of the neural network include a DNN. The coefficients may include coefficients of a layer of the neural network, for example, coefficients of a convolution layer. Examples of the convolution layer include a one-dimensional convolution layer, a two-dimensional convolution layer, a depthwise convolution layer, and a pointwise convolution layer.

The coefficient matrix km has a filter direction dimension. The filter direction is also referred to as an output channel direction or the like. There are as many filters as there are output channels. The output channels correspond to, for example, color types. Convolution processing for different filters can be considered (treated) independently since their processing results do not affect each other.

The coefficient matrix km also has dimensions of directions other than the filter direction. Examples of the other directions include a depth direction, a height direction, and a width direction. These directions are also referred to as an input channel direction, a height direction, a width direction, and the like.

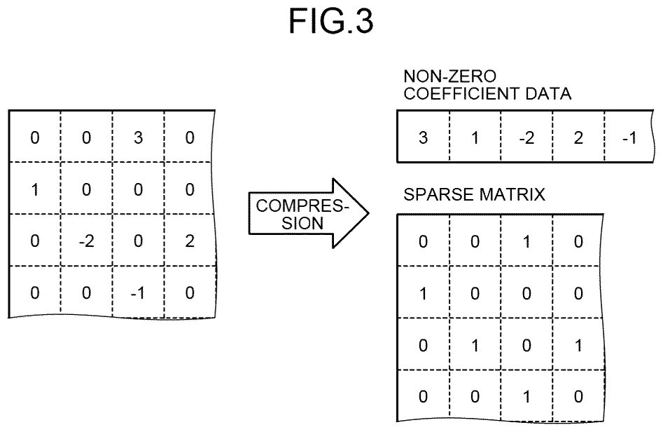

The coefficient matrix km may be a coefficient matrix of a neural network adjusted to include many zero coefficients. For such adjustment, for example, the Pruning technology described above is used. By including many zero coefficients, the coefficient matrix km can be efficiently compressed. This will be described with reference to FIG. 3.

FIG. 3 is a diagram illustrating an example of compression. 16 coefficient portions in a matrix are schematically illustrated. In this example, it is assumed that each coefficient is described in eight bits. The amount of data of the 16 coefficient portions is 128 (=16×8) bits.

Data after compression is referred to as compressed data. The compressed data includes non-zero coefficient data and a sparse matrix. In the non-zero coefficient data, non-zero coefficients in a matrix before compression are described with raw bits. In the sparse matrix, each of a zero coefficient and the non-zero coefficient in the matrix before compression is described with one bit. When values are read in order from the sparse matrix (in order of raster scan in this example), values of coefficients corresponding to positions with a value of 1 are sequentially stored in the non-zero coefficient data.

In this example, the non-zero coefficient data includes 5 coefficients, and the amount of data of the non-zero coefficient data is 40 (=5×8=40) bits. Since each value in the sparse matrix is described with one bit, the amount of data of the sparse matrix is 16 (=16×1) bits. The compression reduces the amount of data to 56 (=40+16) bits.

Returning to FIG. 1, the information processing apparatus 1 will be further described. The information processing apparatus 1 includes a processing unit 11 and a storage unit 12. The processing unit 11 includes one or more processors (for example, a CPU and the like). The storage unit 12 stores information necessary for processing by the processing unit 11. A program 121 is exemplified as the information stored in the storage unit 12. The program 121 is an information processing program (software) for causing a computer to function as the information processing apparatus 1.

The processing unit 11 generates the divided compressed data do by dividing and compressing the coefficient matrix km. The compression is performed based on the above-described compression principle.

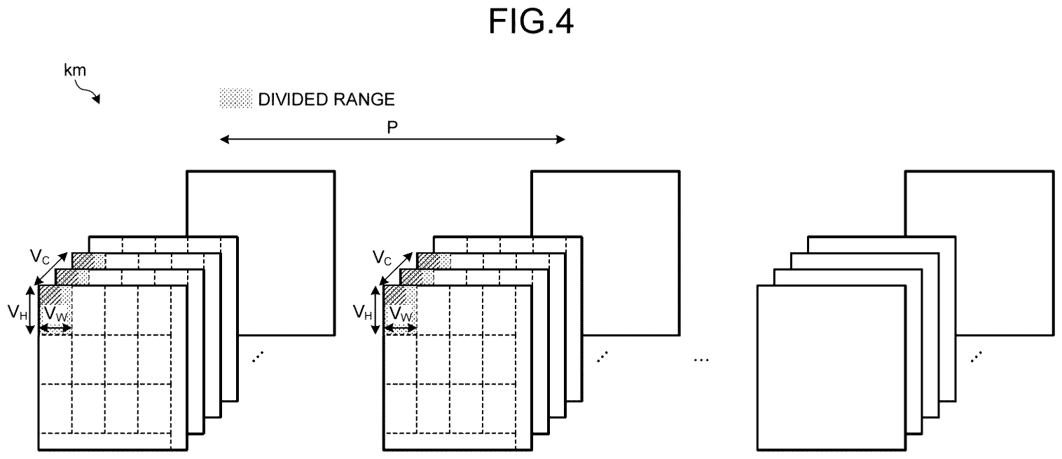

FIG. 4 is a diagram illustrating an example of division compression. An example of the divided range is illustrated by hatching. The divided range defines a range of coefficients that are compressed at a time. That is, the coefficients within the divided range are collectively compressed (compressed at a time).

The divided range processing for different filters can be treated independently since their processing results do not affect each other. The divided range is arbitrarily determined to be unable to be set freely in the filter direction but to be able to be set freely in the other directions. The divided range in the filter direction is determined according to the number of filters unique to the compressed expression. The divided range in the other directions is arbitrarily set so as to absorb the influence of the shape of the filter, for example.

The number of filters (the number of data pieces) in the filter direction that defines the divided range is referred to as the number of filters P. The number of filters P is the number of filters that can be compressed at the same time, and is determined according to a hardware configuration of the information processing apparatus 2, for example. In the example illustrated in FIG. 4, the number of filters P is two.

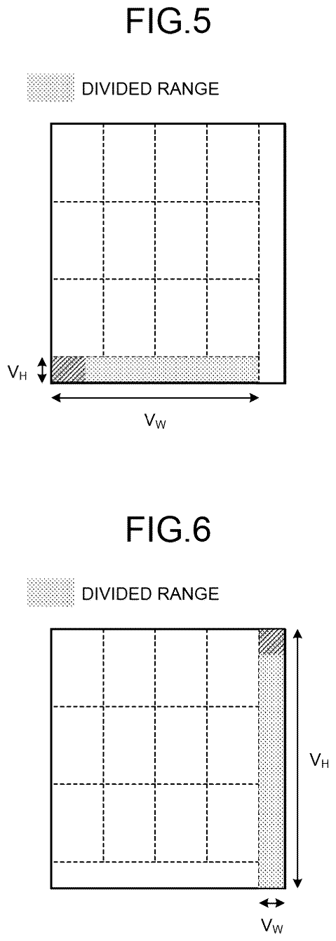

The number of data pieces in the depth direction that defines the divided range is referred to as the number of data pieces Vc in the drawing. The number of data pieces in the height direction that defines the divided range is referred to as the number of data pieces V_{H} in the drawing. The number of data pieces in the width direction that defines the divided range is referred to as the number of data pieces V_{W} in the drawing. The upper limit of the data size of the range defined by the number of data pieces Vc, the number of data pieces V_{H}, and the number of data pieces V_{W} is referred to as a data size V. The data size V is a data size of each filter in the divided range. The data size of the number of data pieces obtained by multiplying the number of data pieces Vc, the number of data pieces V_{H}, and the number of data pieces V_{W} is limited to the data size V or smaller. The data size V is a data size corresponding to the internal buffer size of the information processing apparatus 2 that restores and uses the divided compressed data dc. In other words, the divided range is determined so that the data size of the divided range for each filter is equal to or smaller than the data size corresponding to the internal buffer size of the information processing apparatus 2. As long as such conditions are satisfied, the number of data pieces V_{C}, the number of data pieces V_{H}, and the number of data pieces V_{W} can be arbitrarily set. Among the shapes of the divided ranges, the shape defined in three dimensions of the depth direction, the height direction, and the width direction can be flexibly changed. This will be described with reference to FIGS. 5 and 6.

FIGS. 5 and 6 are diagrams illustrating examples of the shapes of the divided ranges. The divided range illustrated in FIG. 5 has a shape in which the number of data pieces V_{H} in the height direction is small and the number of data pieces V_{W} in the width direction is large as compared with the divided range of FIG. 4. The divided range illustrated in FIG. 6 has a shape in which the number of data pieces V_{H} in the height direction is large and the number of data pieces V_{W} in the width direction is small as compared with the divided range of FIG. 4.

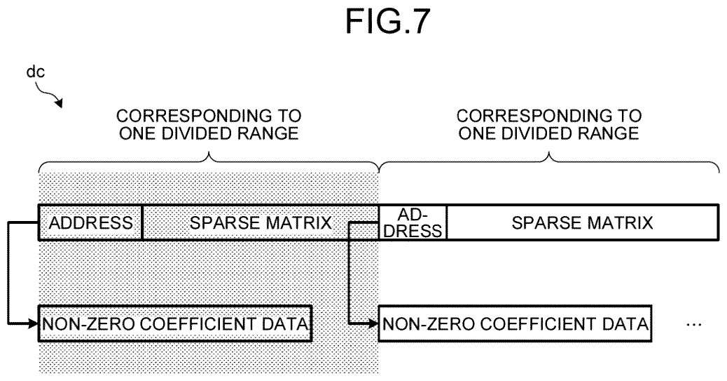

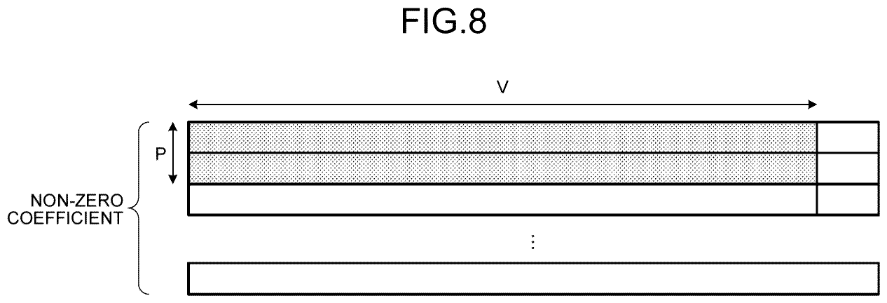

Since the divided range can be set freely as described above, the coefficient matrix km having various shapes can be efficiently compressed. The processing unit 11 generates the divided compressed data dc by compressing data over all the divided ranges of the coefficient matrix km. The divided compressed data dc thus generated will be described with reference to FIGS. 7 and 8.

FIG. 7 is a diagram illustrating an example of the divided compressed data dc. The divided compressed data dc includes an address, a sparse matrix, and non-zero coefficient data for each divided range. The address is data for specifying a position (for example, a head position) of the non-zero coefficient data. In the sparse matrix, each of a zero coefficient and a non-zero coefficient in the coefficient matrix km for each filter is described with one bit. In the non-zero coefficient data, the non-zero coefficients in the coefficient matrix km for each filter are described with raw bits. Incidentally, the address and the sparse matrix can also be referred to as metadata.

FIG. 8 is a diagram illustrating an example of a sparse matrix. The maximum number of filters that can be allocated to the sparse matrix (the number of filters that can be compressed at a time) may be equal to or larger than the number of filters P. The data size of each filter that can be allocated to the sparse matrix may be the same as or larger than the data size V.

Assuming that the number of filters to be compressed is N, the amount of data in the depth direction is C, the amount of data in the height direction is H, and the amount of data in the width direction is W, when the compression rate is increased to the maximum, ceil (N/P)×ceil ((C×H×W)/V) divided ranges, that is, sets of addresses, sparse matrices, and non-zero coefficient data pieces are generated. ceil denotes a ceiling function, and a fraction is rounded up to an integer.

### EXAMPLES

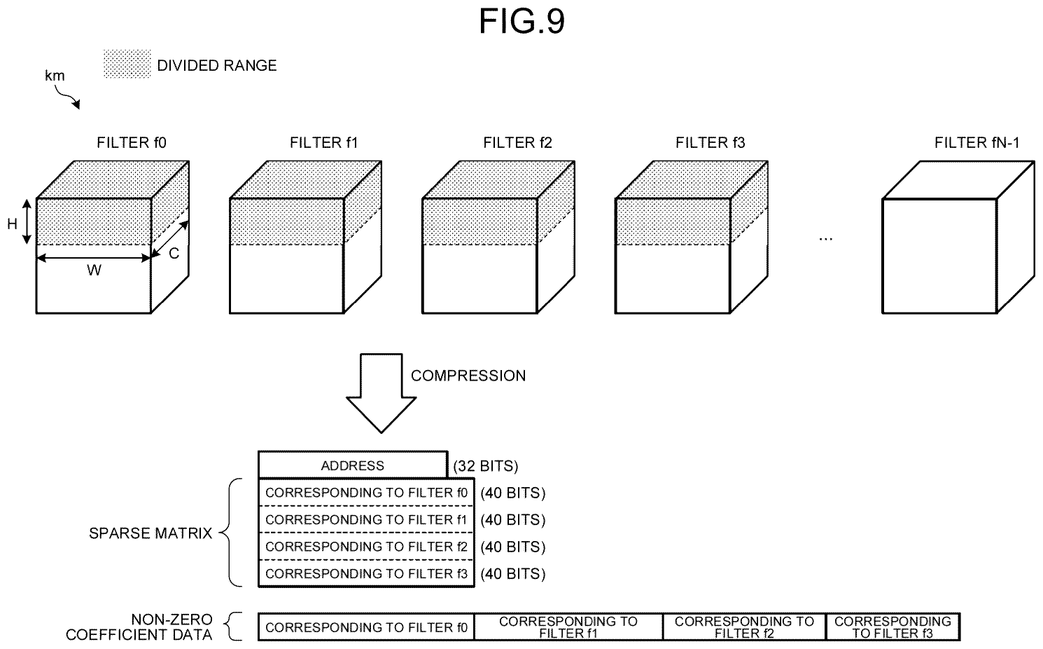

FIG. 9 is a diagram illustrating a specific example of the coefficient matrix km and the divided compressed data dc. The coefficient matrix km is illustrated on the upper side of FIG. 9. Filters are referred to as a filter f0 to a filter fN−1 in the drawing. Exemplary divided ranges correspond to four filters, filter f0 to filter f3.

On the lower side of FIG. 9, an address, a sparse matrix, and non-zero coefficient data corresponding to the above-described divided ranges are illustrated. The data size of the address and the sparse matrix is fixed to 192 bits. The data size of the address is 32 bits. The sparse matrix includes data corresponding to the filters f0 to f3. The maximum data size of the data corresponding to each filter is 40 bits. That is, the divided range is determined so that the data size of each filter in the sparse matrix is 40 bits or smaller (data size V=40 bits). The non-zero coefficient data includes data corresponding to the filters f0 to f3.

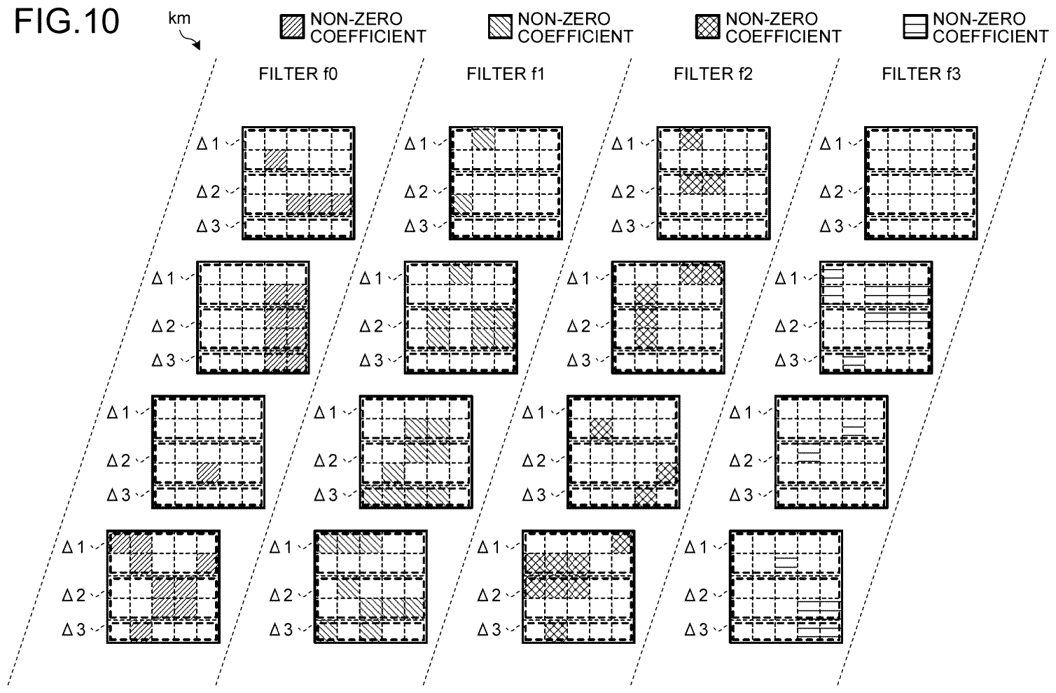

FIG. 10 is a diagram illustrating a specific example of the divided range. The exemplified coefficient matrix km is a coefficient matrix used for two-dimensional convolution processing, and has a four-dimensional shape in the filter direction, the depth direction, the height direction, and the width direction. As described above, the number of filters P in the divided range is four. The divided range is determined so that the data size of each filter in the sparse matrix is 40 bits or smaller. Hereinafter, the divided range is sometimes represented as a divided range Δ (the number of filters P, the number of data pieces in the depth direction, the number of data pieces in the height direction, and the number of data pieces in the width direction). In the example illustrated in FIG. 10, as indicated by a broken line, the coefficient matrix km is divided and compressed using a combination of a divided range Δ1 (4, 4, 2, 5), a divided range Δ2 (4, 4, 2, 5), and a divided range Δ3 (4, 4, 1, 5).

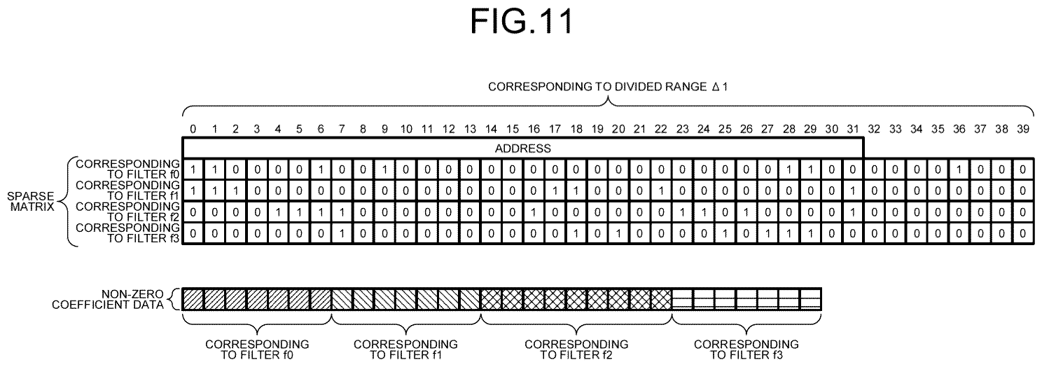

FIG. 11 is a diagram illustrating a portion corresponding to the divided range Δ1 in the divided compressed data dc. For facilitating understanding, 0 to 39 corresponding to 40 bits are written above the address. Whether the coefficient is a zero coefficient or a non-zero coefficient is checked in the order of the filter direction (ascending order), the depth direction, the height direction, and the width direction. In the case of the non-zero coefficient, 1 is written to the corresponding position of the sparse matrix. In the case of the zero coefficient, 0 is written to the corresponding position of the sparse matrix.

For example, referring to the divided range Δ1 illustrated at the bottom left of FIG. 10 described above, a non-zero coefficient, a non-zero coefficient, a zero coefficient, a zero coefficient, a zero coefficient, a zero coefficient, a non-zero coefficient, a zero coefficient, a zero coefficient, and a non-zero coefficient are confirmed in this order. As illustrated in FIG. 11, 1, 1, 0, 0, 0, 0, 1, 0, 0, 1 are sequentially written in a portion corresponding to the filter f0 in the sparse matrix. In non-zero coefficient data, the non-zero coefficients are directly written. By performing similar processing in the depth direction, the divided range Δ1 corresponding to the filter f0 is compressed. Similarly, the divided range Δ1 corresponding to each of the filters f1 to f3 is also compressed. The compression of a portion corresponding to the divided range Δ1 in the divided compressed data dc as illustrated in FIG. 11 is completed.

In the example illustrated in FIG. 11, the number of non-zero coefficients is 30. Assuming that the data size of each coefficient is eight bits, the amount of data before compression is 1280 (=4×4×2×5×8) bits. The amount of data after compression is the sum of 192 bits of the address and the sparse matrix and 240 (=30×8) bits of the non-zero coefficient data, that is, 432 bits. The amount of data can be compressed to about ⅓.

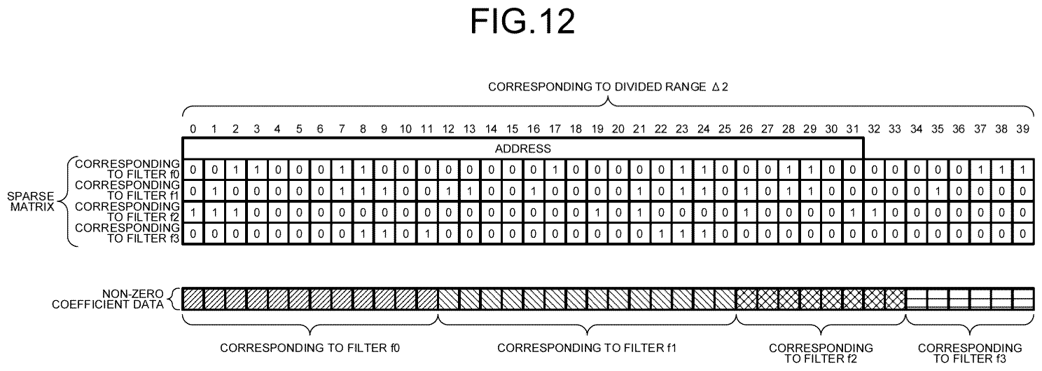

FIG. 12 is a diagram illustrating a portion corresponding to the divided range Δ2 in the divided compressed data dc. Writing of data is the same as described above, and thus its description is omitted.

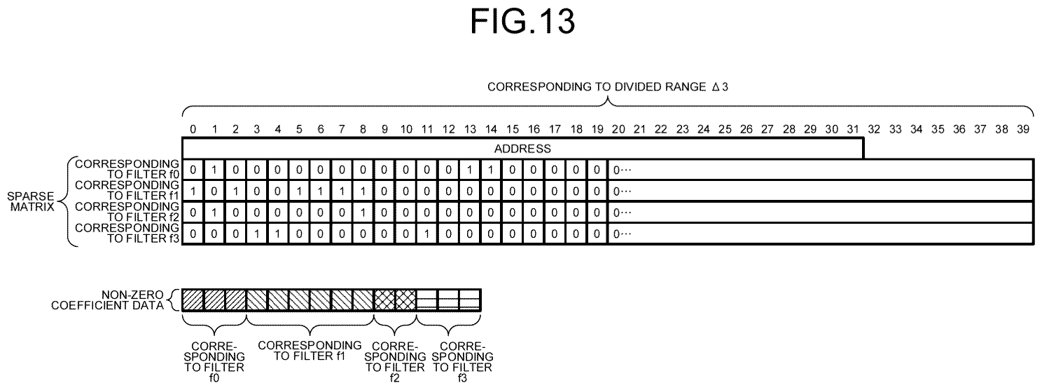

FIG. 13 is a diagram illustrating a portion corresponding to the divided range Δ3 in the divided compressed data dc. Writing of data is the same as described above, and thus its description is omitted. Note that, the divided range Δ3 is set narrower than the previous divided range Δ1 and divided range Δ2, and the data size of each filter in the sparse matrix is 20 bits. Among the allocated 40 bits, only the front. 20 bits are used. The remaining portions are not used, and all of them are written with 0.

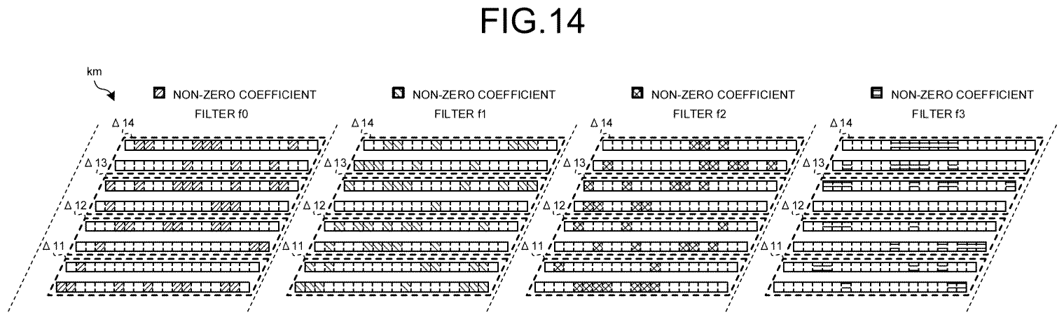

FIG. 14 is a diagram illustrating another specific example of the divided range. The exemplified coefficient matrix km is a coefficient matrix used for one-dimensional convolution processing, and has a three-dimensional shape in the filter direction, the depth direction, and the width direction. In this example, the number of filters P in the divided range is 4, the number of data pieces in the depth direction is 3, the number of data pieces in the height direction is 1, and the number of data pieces in the width direction is 20.

There is no need for compression in the height direction, and this compression is allocated to compression in the width direction in this example. As indicated by a broken line, the coefficient matrix km is divided and compressed in the divided range Δ11 to the divided range Δ14 (4, 2, 1, 20) having the same shape.

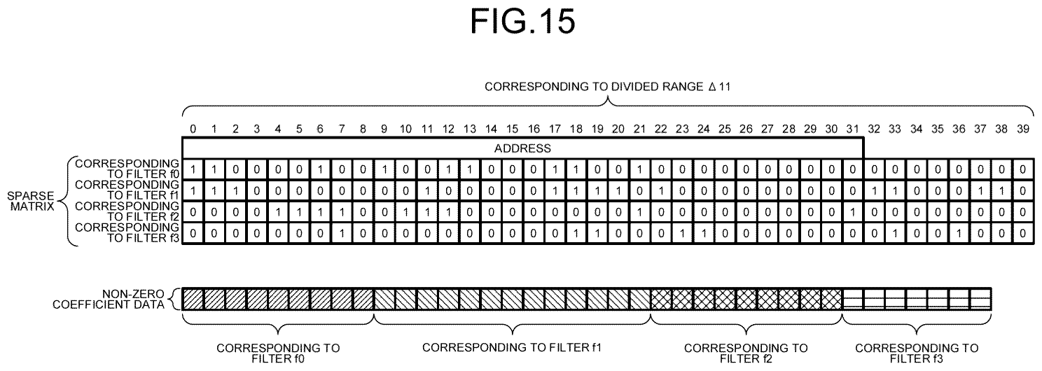

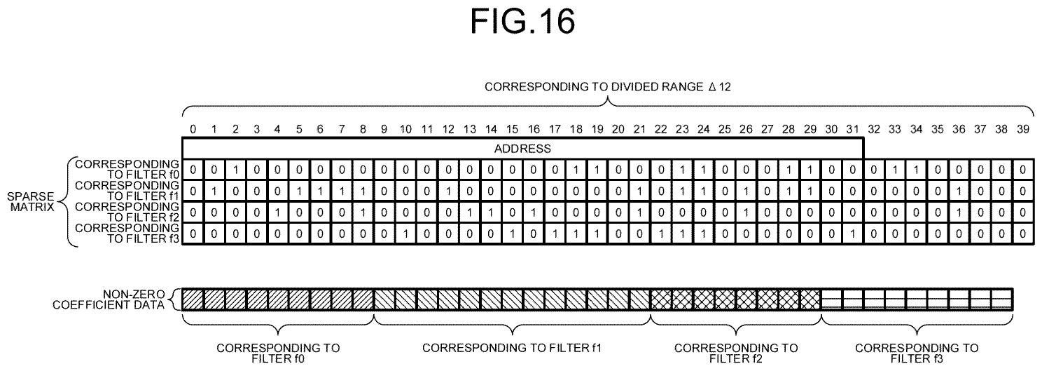

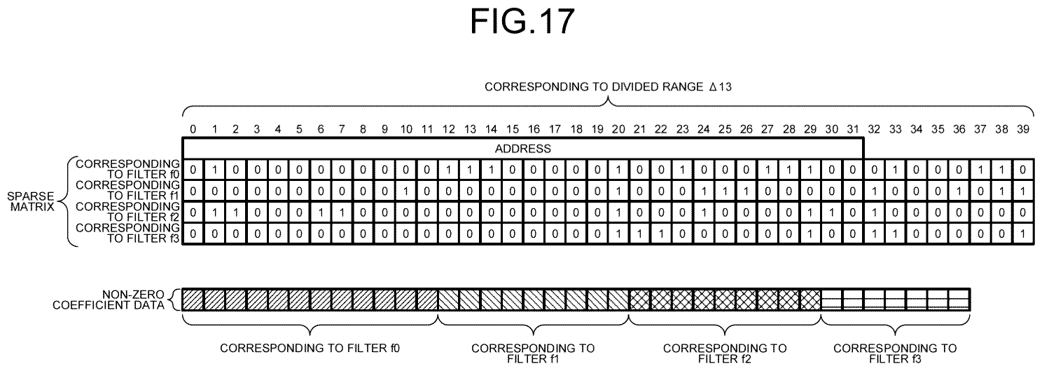

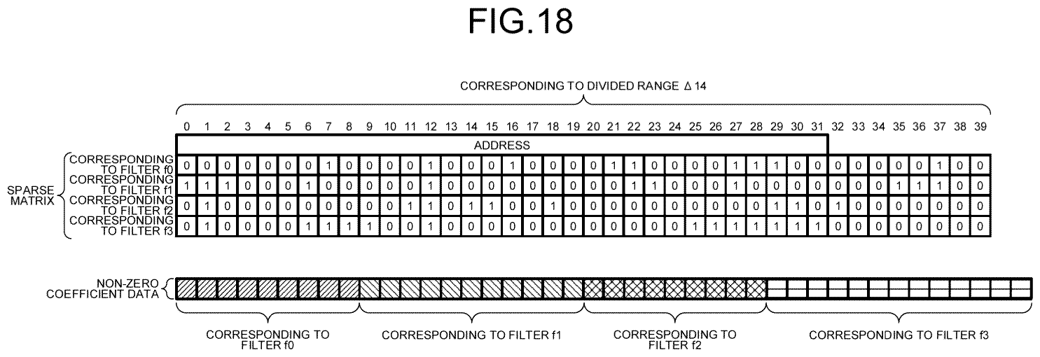

FIGS. 15 to 18 are diagrams illustrating portions corresponding to the divided range Δ11 to the divided range Δ14 in the divided compressed data do. Writing of data is the same as described above, and thus its description is omitted.

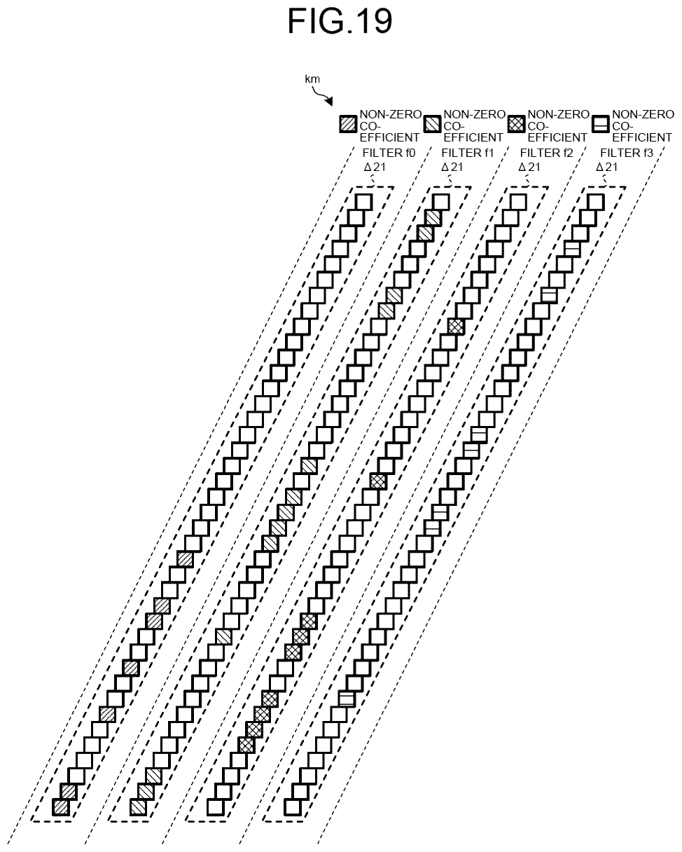

FIG. 19 is a diagram illustrating another specific example of the divided range. The exemplified coefficient matrix km is a coefficient matrix used for pointwise convolution processing, and has a two-dimensional shape in the filter direction and the depth direction. In this example, the number of filters P in the divided range is 4, the number of data pieces in the depth direction is 40, the number of data pieces in the height direction is 1, and the number of data pieces in the width direction is 1.

There is no need for compression in the height direction and the width direction, and this compression is allocated to compression in the depth direction in this example. As indicated by a broken line, the coefficient matrix km is compressed by one divided range Δ21 (4, 40, 1, 1).

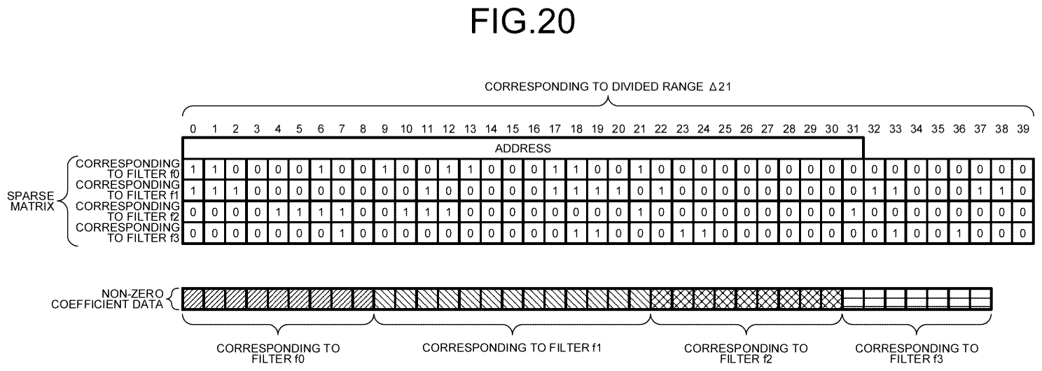

FIG. 20 is a diagram illustrating a portion corresponding to the divided range Δ21 in the divided compressed data do. Writing of data is the same as above, and thus its description is omitted.

For example, as described above, by allowing the divided range to be set freely in the depth direction, the height direction, and the width direction, it is possible to absorb a difference in the various shapes of the coefficient matrix km and efficiently compress them. That is, a high compression rate can be realized by changing the allocation of the number of data pieces C in the depth direction, the number of data pieces H in the height direction, and the number of data pieces W in the width direction each time.

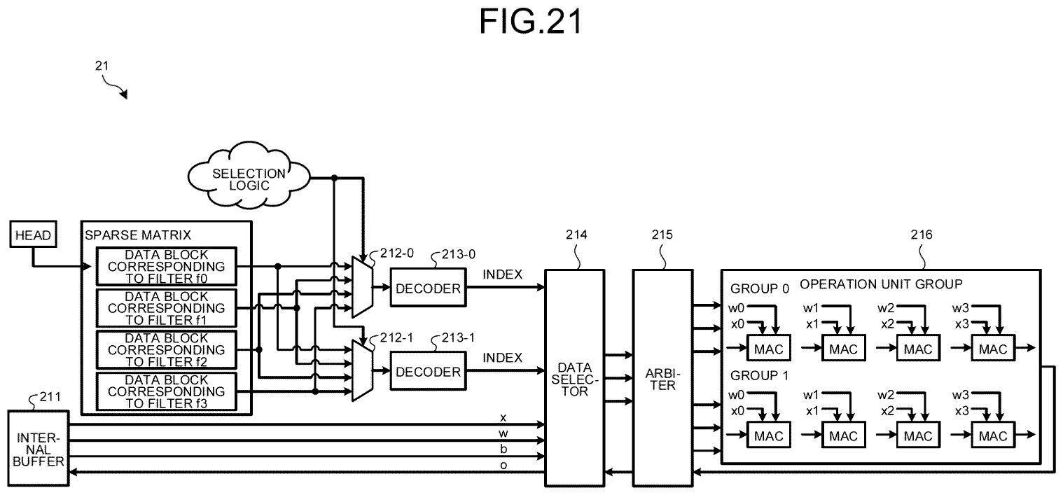

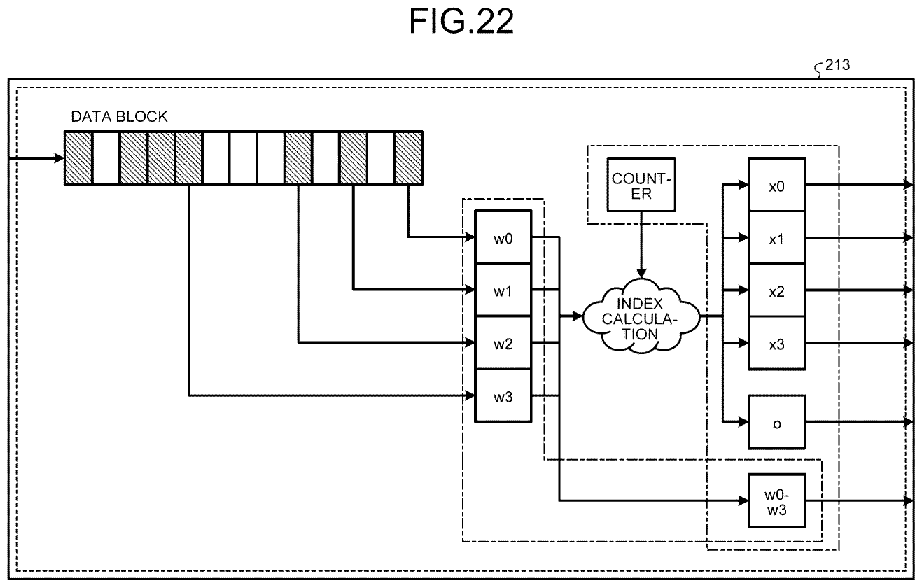

Returning to FIG. 1, the information processing apparatus 2 will be further described. The information processing apparatus 2 includes a processing unit 21 and a storage unit 22. The processing unit 21 restores the divided compressed data dc and executes processing using a neural network. The processing unit 21 may include dedicated hardware such as a GPU and an accelerator. Examples of information stored in the storage unit 22 include a program 221 and the divided compressed data dc generated by the information processing apparatus 1. The program 221 is an information processing program (software) for causing a computer to function as the information processing apparatus 2. The restoration of the divided compressed data do will be described with reference to FIGS. 21 and 22.

FIGS. 21 and 22 are diagrams schematically illustrating processing by the processing unit 21. FIG. 21 illustrates some components related to restoration processing and arithmetic processing. FIG. 22 schematically illustrates processing by a decoder 213. In this example, the sparse matrix corresponding to the filters f0 to f3 as described in the above specific example is processed. For convenience, hereinafter, data pieces corresponding to the filters f0 to f3 in the sparse matrix are also referred to as data blocks. As components related to processing, an internal buffer 211, multiple multiplexers 212, multiple decoders 213, a data selector 214, an arbiter 215, and an operation unit group 216 are illustrated with reference signs. As the multiple multiplexers 212, a multiplexer 212-0 and a multiplexer 212-1 are exemplified. As the multiple decoders 213, a decoder 213-0 and a decoder 213-1 are exemplified.

The non-zero coefficient data is read into the internal buffer by referring to the address described previously. By interpreting data blocks at the timing of decoding to be described later, a necessary non-zero coefficient is read from an appropriate position of the internal buffer. The processing unit 21 exclusively allocates the data blocks to the multiple decoders 213. Each decoder 213 decodes a non-zero coefficient (i.e., a coefficient whose value corresponds to 1) described in the allocated data blocks. The data blocks are processed in parallel by the multiple decoders 213.

In this example, the processing unit 21 designates (the position of) the head of an unprocessed data block by a head. The designated data block is allocated to the decoder 213 in an idle state via the multiplexer 212 to which a selection logic is given. Since the operation results of the data blocks do not affect each other, parallel processing by the multiple decoders 213 is possible.

Due to the number of Is included in each data block, the number of cycles required to process the data block may vary. The decoders 213 can proceed with processing without being synchronized with each other. The processing unit 21 allocates an unallocated data block to the decoder 213 that has decoded all the non-zero coefficients described in the corresponding data block among the multiple decoders 213. For example, even if the decoder 213-0 has not completed the processing on the data block, if the decoder 213-1 has completed the processing on the data block, an unallocated data block is allocated to the decoder 213-1. The decoder 213-1 proceeds with processing on the newly allocated data block without waiting for completion of the processing on the data block by the decoder 213-0. This makes it possible to suppress idling of the decoder 213 (a state of waiting for completion of processing of another decoder 213).

Processing and the like of the decoder 213 are illustrated in FIG. 22. Processing surrounded by a broken line is executed for each filter. Processing surrounded by a one-dot chain line is executed for each depth, each height, and each width. Processing surrounded by a two-dot chain line is executed for each height and each width. A value (weight w0 or the like to be described later) in the processing surrounded by the one-dot chain line is held until the processing surrounded by the corresponding two-dot chain line is completed.

The positions of 1 in the data block are illustrated by hatching. Multiple positions are detected and corresponding coefficients are stored. As the coefficients, weights w, more specifically, a weight w0 to a weight w3 are exemplified. According to counting by a counter, indexes indicating the positions of the weights w0 to w3 in the internal buffer 211 are calculated. In order to align the processing cycles, reg may be interposed in the indexes of the weights w (for example, flip-flop or the like may be interposed in the indexes of the weights w to align the processing cycles). Based on the calculated indexes, a combination of an input x0 to an input x3 and an output o for a product-sum operation using the weight w0 to the weight w3 is calculated.

The data selector 214 (FIG. 21) selects the input x, the weight w, and a bias b stored in the buffer. These selected data are sent to the operation unit group 216 via the arbiter 215.

The operation unit group 216 includes multiple product-sum operation units MAC. In this example, the multiple product-sum operation units MAC is divided into a group 0 corresponding to the decoder 213-0 and a group 1 corresponding to the decoder 213-1 and used. This makes the product-sum operation units MAC be connected less freely, which eases the complexity of connection. Each product-sum operation unit MAC executes a product-sum operation of the corresponding weight w and input x, more specifically, the corresponding one of the weight w0 to the weight w3 and the corresponding one of the input x0 to the input x3. The operation of the bias b may also be included. The output o obtained by the operation is sent to the internal buffer 211 via the arbiter 215 and the data selector 214.

A product-sum operation is performed on all the inputs x, the bias b, and the output o involving the coefficients detected in the data block so as not to decode the same data block multiple times. This series of processing is repeated until there is no unprocessed 1 (coefficient before decoding) in the data block. As a result, decoding processing can be performed only in processing cycles proportional to the number of Is in the data block.

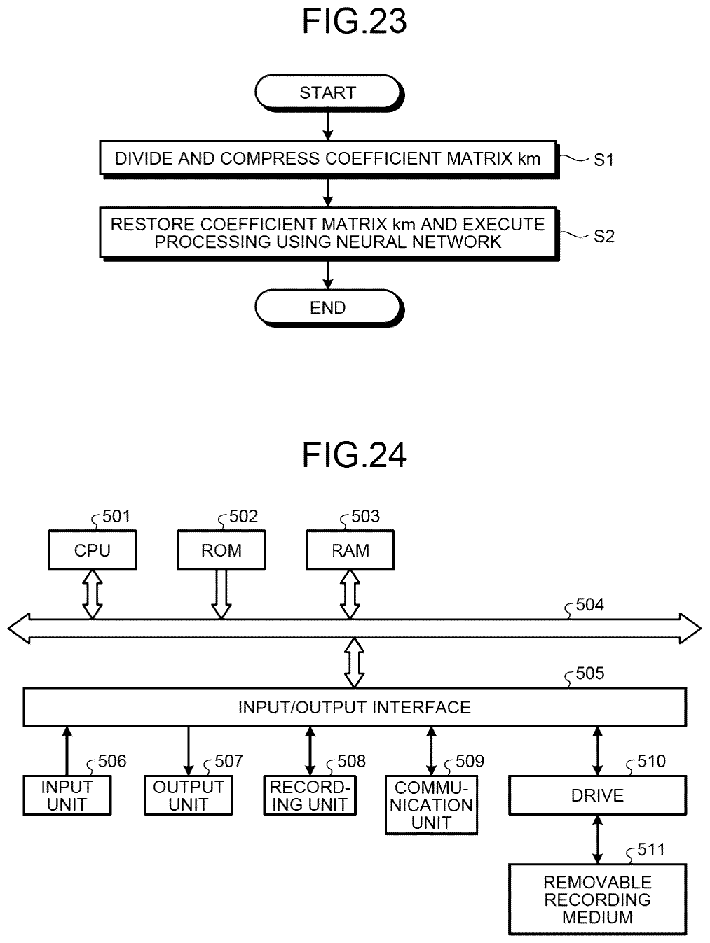

FIG. 23 is a flowchart illustrating an example of processing (information processing method) executed by the information processing apparatus 1 and the information processing apparatus 2.

In Step S1, the coefficient matrix km is divided and compressed. This processing is executed by the processing unit 11 of the information processing apparatus 1, for example. The processing unit 11 generates the divided compressed data dc by dividing and compressing the coefficient matrix km in the divided range designed to be unable to be set freely in the filter direction but to be able to be set freely in the other directions. The details are as described above, and the description will not be repeated.

In Step S2, the coefficient matrix km is restored, and processing using a neural network is executed. This processing is executed by the processing unit 21 of the information processing apparatus 2, for example. The details are as described above, and the description will not be repeated.

### 2. Modified Example

The disclosed technology is not limited to the above embodiment. Some modified examples will be described.

In the example of FIGS. 9 to 20 described above, the case where the divided range in the filter direction, that is, the number of filters P compressed at a time is four has been described as an example. However, the number of filters P may be other than four. The number of filters P may be one or an arbitrary integer of two or more.

The case where the data size of each filter in the divided range is 40 bits has been described above as an example. However, the data size may be any data size other than 40 bits.

The address may be any address as long as the position of the head of the corresponding non-zero coefficient data can be specified. The address may be an absolute address or a relative address.

In the above embodiment, the case where the data size V is determined in the divided range as the upper limit of the data size corresponding to the product of the number of data pieces V_{C} in the depth direction, the number of data pieces V_{H} in the height direction, and the number of data pieces V_{W} in the width direction has been described as an example. However, the upper limit may be individually determined for each of the number of data pieces V_{C}, the number of data pieces V_{H}, and the number of data pieces V_{W}. At least a part of the number of data pieces may be fixed.

In the above embodiment, the case where the information processing apparatus 1 that compresses the coefficient matrix km and the information processing apparatus 2 that restores the coefficient matrix km are different apparatuses has been described as an example. However, the information processing apparatus 1 and the information processing apparatus 2 may be the same apparatus.

In the above embodiment, the depth direction, the height direction, and the width direction have been described as an example of directions other than the filter direction. However, the other directions may be at least one direction other than the filter direction. The other directions may include directions other than the depth direction, the height direction, and the width direction.

### 3. Hardware Configuration

FIG. 24 is a block diagram illustrating a hardware configuration example of the apparatus. For example, the information processing apparatus 1 and the information processing apparatus 2 are realized using a general-purpose computer as illustrated. Note that, for example, the processing unit 21 of the information processing apparatus 2 may include dedicated hardware such as a GPU and an accelerator as described above, for example.

In the computer, a CPU 501, a read only memory (ROM) 502, and a random access memory (RAM) 503 are mutually connected by a bus 504.

An input/output interface 505 is further connected to the bus 504. An input unit 506, an output unit 507, a recording unit 508, a communication unit 509, and a drive 510 are connected to the input/output interface 505.

The input unit 506 includes a keyboard, a mouse, a microphone, an imaging element, and the like. The output unit 507 includes a display, a speaker, and the like. The recording unit 508 includes a hard disk, a nonvolatile memory, and the like. The communication unit 509 includes a network interface and the like. The drive 510 drives a removable recording medium 511 such as a magnetic disk, an optical disk, a magneto-optical disk, or a semiconductor memory.

In the computer configured as described above, for example, the CPU 501 loads a program (for example, the program 121 and the program 221 in FIG. 1), recorded in the recording unit 508, into the RAM 503 via the input/output interface 505 and the bus 504 and executes the program, whereby the above-described series of processing is performed.

The program executed by the computer (CPU 501) can be provided by being recorded in the removable recording medium 511 as a package medium or the like, for example. Further, the program can be provided via a wired or wireless transmission medium such as a local area network, the Internet, or digital satellite broadcasting.

In the computer, the program can be installed in the recording unit 508 via the input/output interface 505 by mounting the removable recording medium 511 to the drive 510. Further, the program can be received by the communication unit 509 via a wired or wireless transmission medium and installed in the recording unit 508. In addition, the program can be installed in the ROM 502 or the recording unit 508 in advance.

### 4. Example of Effect

According to the present disclosure, a technology suitable for division of processing using a neural network is provided. One of the disclosed technologies is the information processing apparatus 1. As has been described with reference to FIGS. 1 to 8 and the like, the information processing apparatus 1 includes the processing unit 11 that generates the divided compressed data dc by dividing and compressing the coefficient matrix km of the neural network, which has dimensions in the filter direction (output channel direction) and in the other directions (for example, at least one of the depth direction, the height direction, and the width direction (input channel direction, height direction, and width direction)) and is adjusted to include many zero coefficients, in the divided range designed to be unable to be set freely in the filter direction but to be able to be set freely in the other directions.

According to the information processing apparatus 1 described above, since the divided range is able to be set freely to some extent, the coefficient matrix km having various shapes can be efficiently compressed.

As has been described with reference to FIGS. 7 and 8 and the like, the divided compressed data de may include the non-zero coefficient data in which the non-zero coefficients in the coefficient matrix km for each filter are described with raw bits, the sparse matrix in which each of the zero coefficient and the non-zero coefficient in the coefficient matrix km for each filter is described with one bit, and the address that specifies the position of the non-zero coefficient data. For example, by generating the divided compressed data de including the non-zero coefficient data and the sparse matrix in this manner, the coefficient matrix km can be compressed (encoded). By including the address in the divided compressed data do, it is possible to prevent the position of the non-zero coefficient from being lost.

As has been described with reference to FIGS. 1, 4 to 8, and the like, the divided range may be determined so that the data size of each filter in the sparse matrix is equal to or smaller than the data size corresponding to the internal buffer size of the apparatus (information processing apparatus 2) that restores and uses the divided compressed data dc. This facilitates division of processing using the neural network in the information processing apparatus 2.

As has been described with reference to FIGS. 2 and 10 to 20 and the like, the coefficient matrix km may include the coefficient matrix of the convolution layer of the neural network, and the convolution layer may include at least one of the one-dimensional convolution layer, the two-dimensional convolution layer, the Depthwise convolution layer, and the pointwise convolution layer. For example, the coefficient matrix km of such various convolution layers can be efficiently compressed.

The information processing apparatus 2 described with reference to FIGS. 1 to 8, 21, 22, and the like is also one of the disclosed technologies. The information processing apparatus 2 includes the processing unit 21 that restores the divided compressed data de generated by dividing and compressing the coefficient matrix km of the neural network, which has dimensions in the filter direction (output channel direction) and in the other directions (for example, at least one of the depth direction, the height direction, and the width direction (input channel direction, height direction, and width direction)) and is adjusted to include many zero coefficients, in the divided range designed to be unable to be set freely in the filter direction but to be able to be set freely in the other directions. This facilitates division of processing using the neural network in the information processing apparatus 2.

As has been described with reference to FIGS. 21, 22, and the like, the processing unit 21 may exclusively allocate the data (data block) for each filter in the sparse matrix to the multiple decoders 213, each decoder 213 may decode the non-zero coefficient described in the allocated data, and the processing unit 21 may allocate unallocated data, among the data for each filter in the divided compressed data dc, to the decoder 213 that has decoded all the non-zero coefficients described in the corresponding data among the multiple decoders 213. As a result, the non-zero coefficient can be efficiently decoded.

The information processing method described with reference to FIG. 23 and the like is also one of the disclosed technologies. The information processing method includes generating the divided compressed data dc by dividing and compressing the coefficient matrix km of the neural network, which has dimensions in the filter direction (output channel direction) and in the other directions (for example, at least one of the depth direction, the height direction, and the width direction (input channel direction, height direction, and width direction)) and is adjusted to include many zero coefficients, in the divided range designed to be unable to be set freely in the filter direction but to be able to be set freely in the other directions (Step S1). By such an information processing method, as has been described above, the coefficient matrix km having various shapes can also be efficiently compressed.

Note that, the effects described in the present disclosure are merely examples and are not limited to the disclosed contents. There may be other effects.

Although the embodiment of this disclosure has been described above, the technical scope of this disclosure is not limited to the above-described embodiment as it is, and various modifications can be made without departing from the gist of this disclosure. In addition, constituents of different embodiments and modifications may be appropriately combined.

Note that, the present technology can also have the following configuration.

(1) An information processing apparatus comprising
a processing unit that generates divided compressed data by dividing and compressing a coefficient matrix of a neural network, which has dimensions in a filter direction and in other directions and is adjusted to include many zero coefficients, in a divided range designed to be unable to be set freely in the filter direction but to be able to be set freely in the other directions.

(2) The information processing apparatus according to (1), wherein
the divided compressed data includes non-zero coefficient data in which non-zero coefficients in the coefficient matrix for each of filters are described with raw bits, a sparse matrix in which each of the zero coefficients and the non-zero coefficients in the coefficient matrix for each of the filters is described with one bit, and an address that specifies a position of the non-zero coefficient data.

(3) The information processing apparatus according to (2), wherein
the divided range is determined so that a data size of each of the filters in the sparse matrix is equal to or smaller than a data size corresponding to an internal buffer size of an apparatus that restores and uses the divided compressed data.

(4) The information processing apparatus according to ay one of (1) to (3), wherein
the other directions include at least one of a depth direction, a height direction, and a width direction.

(5) The information processing apparatus according to any one of (1) to (4), wherein
the coefficient matrix includes a coefficient matrix of a convolution layer of the neural network, and
the convolution layer includes at least one of a one-dimensional convolution layer, a two-dimensional convolution layer, a Depthwise convolution layer, and a pointwise convolution layer.

(6) An information processing apparatus comprising
a processing unit that restores divided compressed data generated by dividing and compressing a coefficient matrix of a neural network, which has dimensions in a filter direction and in other directions and is adjusted to include many zero coefficients, in a divided range designed to be unable to be set freely in the filter direction but to be able to be set freely in the other directions.

(7) The information processing apparatus according to (6), wherein
the divided compressed data includes non-zero coefficient data in which non-zero coefficients in the coefficient matrix for each of filters are described with raw bits, a sparse matrix in which each of the zero coefficients and the non-zero coefficients in the coefficient matrix for each of the filters is described with one bit, and an address that specifies a position of the non-zero coefficient data,
the processing unit exclusively allocates data for each of the filters in the sparse matrix to a plurality of decoders,
each of the decoders decodes the non-zero coefficients described in the allocated data, and
the processing unit allocates unallocated data, among the data for each of the filters in the divided compressed data, to the decoder that has decoded all the non-zero coefficients described in the corresponding data among the plurality of decoders.

(8) The information processing apparatus according to (7), wherein
the divided range is determined so that a data size of the sparse matrix for each of the filters is equal to or smaller than a data size corresponding to an internal buffer size of the information processing apparatus.

(9) The information processing apparatus according to any one of (6) to (8), wherein
the other directions include at least one of a depth direction, a height direction, and a width direction.

(10) The information processing apparatus according to any one of (6) to (9), wherein
the coefficient matrix includes a coefficient matrix of a convolution layer of the neural network, and
the convolution layer includes at least one of a one-dimensional convolution layer, a two-dimensional convolution layer, a Depthwise convolution layer, and a pointwise convolution layer.

(11) An information processing method comprising
generating divided compressed data by dividing and compressing a coefficient matrix of a neural network, which has dimensions in a filter direction and in other directions and is adjusted to include many zero coefficients, in a divided range designed to be unable to be set freely in the filter direction but to be able to be set freely in the other directions.

### REFERENCE SIGNS LIST

1 INFORMATION PROCESSING APPARATUS
11 PROCESSING UNIT
12 STORAGE UNIT
121 PROGRAM
2 INFORMATION PROCESSING APPARATUS
21 PROCESSING UNIT
211 INTERNAL BUFFER
212 MULTIPLEXER
213 DECODER
214 DATA SELECTOR
215 ARBITER
216 OPERATION UNIT GROUP
22 STORAGE UNIT
221 PROGRAM
dc DIVIDED COMPRESSED DATA
km COEFFICIENT MATRIX
501 CPU
502 ROM
503 RAM
504 BUS
505 INPUT/OUTPUT INTERFACE
506 INPUT UNIT
507 OUTPUT UNIT
508 RECORDING UNIT
509 COMMUNICATION UNIT
510 DRIVE
511 REMOVABLE RECORDING MEDIUM

1. An information processing apparatus comprising
a processing unit that generates divided compressed data by dividing and compressing a coefficient matrix of a neural network, which has dimensions in a filter direction and in other directions and is adjusted to include many zero coefficients, in a divided range designed to be unable to be set freely in the filter direction but to be able to be set freely in the other directions.

2. The information processing apparatus according to claim 1, wherein
the divided compressed data includes non-zero coefficient data in which non-zero coefficients in the coefficient matrix for each of filters are described with raw bits, a sparse matrix in which each of the zero coefficients and the non-zero coefficients in the coefficient matrix for each of the filters is described with one bit, and an address that specifies a position of the non-zero coefficient data.

3. The information processing apparatus according to claim 2, wherein
the divided range is determined so that a data size of each of the filters in the sparse matrix is equal to or smaller than a data size corresponding to an internal buffer size of an apparatus that restores and uses the divided compressed data.

4. The information processing apparatus according to claim 1, wherein
the other directions include at least one of a depth direction, a height direction, and a width direction.

5. The information processing apparatus according to claim 1, wherein
the coefficient matrix includes a coefficient matrix of a convolution layer of the neural network, and
the convolution layer includes at least one of a one-dimensional convolution layer, a two-dimensional convolution layer, a Depthwise convolution layer, and a pointwise convolution layer.

6. An information processing apparatus comprising
a processing unit that restores divided compressed data generated by dividing and compressing a coefficient matrix of a neural network, which has dimensions in a filter direction and in other directions and is adjusted to include many zero coefficients, in a divided range designed to be unable to be set freely in the filter direction but to be able to be set freely in the other directions.

7. The information processing apparatus according to claim 6, wherein
the divided compressed data includes non-zero coefficient data in which non-zero coefficients in the coefficient matrix for each of filters are described with raw bits, a sparse matrix in which each of the zero coefficients and the non-zero coefficients in the coefficient matrix for each of the filters is described with one bit, and an address that specifies a position of the non-zero coefficient data,
the processing unit exclusively allocates data for each of the filters in the sparse matrix to a plurality of decoders,
each of the decoders decodes the non-zero coefficients described in the allocated data, and
the processing unit allocates unallocated data, among the data for each of the filters in the divided compressed data, to the decoder that has decoded all the non-zero coefficients described in the corresponding data among the plurality of decoders.

8. The information processing apparatus according to claim 7, wherein
the divided range is determined so that a data size of the sparse matrix for each of the filters is equal to or smaller than a data size corresponding to an internal buffer size of the information processing apparatus.

9. The information processing apparatus according to claim 6, wherein
the other directions include at least one of a depth direction, a height direction, and a width direction.

10. The information processing apparatus according to claim 6, wherein
the coefficient matrix includes a coefficient matrix of a convolution layer of the neural network, and
the convolution layer includes at least one of a one-dimensional convolution layer, a two-dimensional convolution layer, a Depthwise convolution layer, and a pointwise convolution layer.

11. An information processing method comprising
generating divided compressed data by dividing and compressing a coefficient matrix of a neural network, which has dimensions in a filter direction and in other directions and is adjusted to include many zero coefficients, in a divided range designed to be unable to be set freely in the filter direction but to be able to be set freely in the other directions.
